(19) United States
(12) Patent Application Publication
(10) Pub. No.: US 2016/0350568 A1
(43) Pub. Date: Dec. 1, 2016

(54) TWO-DIMENSIONAL (2-D) CODE GENERATING METHOD, DETECTING METHOD, DETECTING APPARATUS, AND ANTI-COUNTERFEIT LABEL

(71) Applicants: VICTOR ZAZZU, BELLE MEAD, NJ (US); WENYU HAN, PRINCETON, NJ (US)

(72) Inventors: VICTOR ZAZZU, BELLE MEAD, NJ (US); WENYU HAN, PRINCETON, NJ (US)

(21) Appl. No.: 15/163,738

(22) Filed: May 25, 2016

(30) Foreign Application Priority Data
May 27, 2015 (CN) 2015102789844

(51) Int. Cl. G06K 7/14; G06K 7/10; G06K 19/06

(52) U.S. Cl. CPC G06K 7/1447; G06K 19/06037; G06K 19/06075; G06K 7/1417; G06K 7/10861; G06K 19/06093; G06Q 30/018

(57) ABSTRACT

There is disclosed a 2-D code generating method, detecting method, detecting apparatus, and anti-counterfeit label. By utilizing the self-correction function of the 2-D code, when the data added with anti-counterfeit information are detected by a normal 2-D code detecting apparatus, it will be corrected to identify data without anti-counterfeit information desired to be presented by the manufacturer, while when the data are detected by a 2-D code detecting apparatus having an anti-counterfeit function, the anti-counterfeit information will be detected based on the uncorrected second data, thereby identifying the authenticity of the identification quickly and simply.

### CLAIM TO PRIORITY

This application claims priority based on Chinese patent application serial number cn 2015102789844 filed May 27, 2015 in China, whose contents are incorporated herein by reference.

### FIELD OF THE INVENTION

The present disclosure relates to the field of anti-counterfeit technology, and more specifically relates to a two-dimensional code generating method, a detecting method, a detecting apparatus, and an anti-counterfeit label.

### BACKGROUND OF THE INVENTION

A two-dimensional (hereafter also “2-D”) code (also referred to as a 2-D bar code) refers to a machine recognizable graphic code that records data symbol information using a black-and-white graph that is formed by distribution of a certain specific geometric pattern on a plane (in a 2-D direction) according to a certain rule. Because code compilation ingeniously leverages the concepts of “0” and “1” bit streams that make up an internal logic foundation of a computer, automatic processing of information may be realized by using a plurality of geometric forms corresponding to the binary system to represent word numerical value information and automatically recognizing it through an image input device or an optoelectronic scanning device.

Meanwhile, a counterfeiter usually deceives a consumer through a counterfeited commodity label. Therefore, a method is urgently desired to identify authenticity of a label quickly and simply.

### SUMMARY OF THE INVENTION

In view of the above, the present disclosure provides a 2-D code generating method, a detecting method, a detecting apparatus, and an anti-counterfeit label.

According to a first aspect of the present disclosure, there is provided a 2-D code generating method, comprising:

generating a 2-D code image having error correction data and anti-counterfeit information based on first data and anti-counterfeit information; and

wherein the first data and/or corresponding 2-D code image are modified in a predetermined manner to add the anti-counterfeit information, the modifying having a predetermined limit such that the 2-D code image having error correction data and anti-counterfeit information can be decoded into the first data based on the error correction data.

Preferably, the generating a 2-D code image having error correction data and anti-counterfeit information based on first data and anti-counterfeit information comprises:

generating a corresponding first 2-D code image having error correction data based on the first data;

modifying at least one region of the first 2-D code image in a predetermined manner to obtain a second 2-D code image;

wherein the modifying is kept within a predetermined limit such that the second 2-D code image can be decoded into the first data based on the error correction data, and the modifying is performed without changing an original image pattern in the corresponding region.

Preferably, the modifying of the first 2-D code image in a predetermined manner to obtain a second 2-D code image comprises:

modifying pixels in at least one predetermined location of the first 2-D code image to a predetermined color.

Preferably, the generating a 2-D code image having error correction data and anti-counterfeit information based on first data and anti-counterfeit information comprises:

adding anti-counterfeit information in the first data to obtain second data;

generating a corresponding error correction codeword based on the first data;

generating a 2-D code image based on the second data and the error correction codeword.

Preferably, the adding anti-counterfeit information in the first data to obtain second data comprises:

replacing at least one-bit data at a predetermined location in the first data with predetermined data or data obtained according to a predetermined rule; or

adding predetermined data or data obtained according to a predetermined rule at a predetermined location in the first data.

Preferably, the anti-counterfeit information and/or the first data are encrypted data.

Preferably, the method further comprises:

forming a micro pattern or a micro text with a pixel pitch of less than 200 microns in a non-key region of the 2-D code image.

Preferably, the method further comprises:

controlling a laser movement track according to the 2-D code image and the micro pattern or a micro text, etching a film metal layer and forming a patterned hollowed-out structure; and

the film comprising a transparent base layer and a metal layer covering the base layer.

According to a second aspect of the present disclosure, there is provided an anti-counterfeit label, comprising:

a substrate;

a graphic layer, the graphic layer being formed with a 2-D code, the 2-D code being generated in accordance with the invention

Preferably, the graphic layer is a metal layer.

Preferably, the metal layer is molded with a holographic anti-counterfeit pattern.

According to a third aspect of the present disclosure, there is provided a 2-D code detecting method, comprising:

performing decoding and error correction based on an original 2-D code image to obtain first data;

obtaining a corresponding first 2-D code image based on the first data; and

detecting whether the original 2-D code image has anti-counterfeit information relative to the first 2-D code image.

Preferably, the detecting whether the original 2-D code image has anti-counterfeit information relative to the first 2-D code image comprises:

detecting whether the original 2-D code image modifies pixels at at least two predetermined positions to a predetermined color relative to the first 2-D code image.

According to a fourth aspect of the present disclosure, there is provided a 2-D code detecting method, comprising:

obtaining second data and an error correction codeword based on a 2-D code image;

performing error correction processing to the second data based on the error correction codeword to obtain first data; and

detecting whether the second data have anti-counterfeit information relative to the first data.

Preferably, detecting whether the second data have anti-counterfeit information relative to the first data comprises:

detecting whether data at at least one predetermined position in the first data are replaced with predetermined data or data obtained according to a predetermined rule; or

detecting whether the at least one predetermined position in the first data is added with the predetermined data or data obtained according to the predetermined rule.

Preferably, the anti-counterfeit information and/or the first data are encrypted data.

According to a fifth aspect of the present disclosure, there is provided a 2-D code generating apparatus, comprising:

an anti-counterfeit information adding unit configured to add anti-counterfeit information in first data to obtain second data;

an error correction codeword generating unit configured to generate a corresponding error correction codeword based on the first data;

a 2-D code generating unit configured to generate a 2-D code image based on the second data and the error correction codeword.

According to a sixth aspect of the present disclosure, there is provided a 2-D code generating apparatus, comprising:

a 2-D code image generating unit configured to generate a corresponding first 2-D code image having error correction data based on first data;

an image modifying unit configured to modify at least one region of the first 2-D code image in a predetermined manner to obtain a second 2-D code image;

wherein the modifying is kept within a predetermined limit such that the second 2-D code image can be decoded into the first data based on the error correction data, and the modifying is performed without changing an original image pattern in the corresponding region.

According to a seventh aspect of the present disclosure, there is provided a 2-D code detecting apparatus, comprising:

an image parsing unit configured to obtain a first data by performing decoding and error correction based on an original 2-D code image;

an image generating unit configured to obtain a corresponding first 2-D code image based on the first data; and

an anti-counterfeit detection unit configured to detect whether the original 2-D code image has anti-counterfeit information relative to the first 2-D code image.

According to an eighth aspect of the present disclosure, there is provided a 2-D code detecting apparatus, comprising:

an image decoding unit configured to obtain second data and an error correction codeword based on a 2-D code image;

an error correction unit configured to perform error correction processing to the second data to obtain a first data; and

an anti-counterfeit detecting unit configured to detect whether the second data have anti-counterfeit information relative to the first data.

According to a ninth aspect of the present disclosure, there is provided a 2-D code detecting apparatus, comprising:

an image obtaining means configured to scan a 2-D code to obtain an original 2-D code image; and

a data processing means configured to perform instructions comprising the following operations:

performing decoding and error correction based on the original 2-D code image to obtain the first data;

obtaining a corresponding first 2-D code image based on the first data; and

detecting whether the original 2-D code image has anti-counterfeit information relative to the first 2-D code image.

Preferably, the data processing means performs the following instructions to detect whether the original 2-D code image has anti-counterfeit information relative to the first 2-D code image:

detecting whether the original 2-D code image modifies pixels at at least two predetermined positions to a predetermined color relative to the first 2-D code image.

Preferably, the data processing means and the image obtaining means are connected via a bus or a local area network or an Internet.

According to a tenth aspect of the present disclosure, there is provided a 2-D code detecting apparatus, comprising:

an image obtaining means configured to scan a 2-D code to obtain a 2-D code image; and

a data processing means configured to perform instructions comprising the following operations:

obtaining first data and an error correction codeword based on the 2-D code image;

performing error correction processing to the first data based on the error correction codeword to obtain second data; and

detecting whether the second data has anti-counterfeit information relative to the first data.

Preferably, the processor performs the following instructions to detect whether the second data has anti-counterfeit information relative to the first data:

detecting whether data at at least one predetermined position in the first data are replaced with predetermined data or data obtained according to a predetermined rule; or

detecting whether the at least one predetermined position in the first data is added with the predetermined data or data obtained according to the predetermined rule.

Preferably, the data processing means and the image obtaining means are connected via a bus or a local area network or an Internet.

By utilizing the self-correction function of the 2-D code, when the data added with anti-counterfeit information are detected by a normal 2-D code detecting apparatus, it will be corrected to identify data without anti-counterfeit information desired to be presented by the manufacturer, while when the data are detected by a 2-D code detecting apparatus having an anti-counterfeit function, the anti-counterfeit information will be detected based on the uncorrected second data, thereby identifying the authenticity of the identification quickly and simply.

### BRIEF DESCRIPTION OF THE PREFERRED EMBODIMENTS

The above and other objectives, features, and advantages of the present disclosure will become much clearer through following description of the embodiments of the present disclosure with reference to the accompanying drawings, wherein:

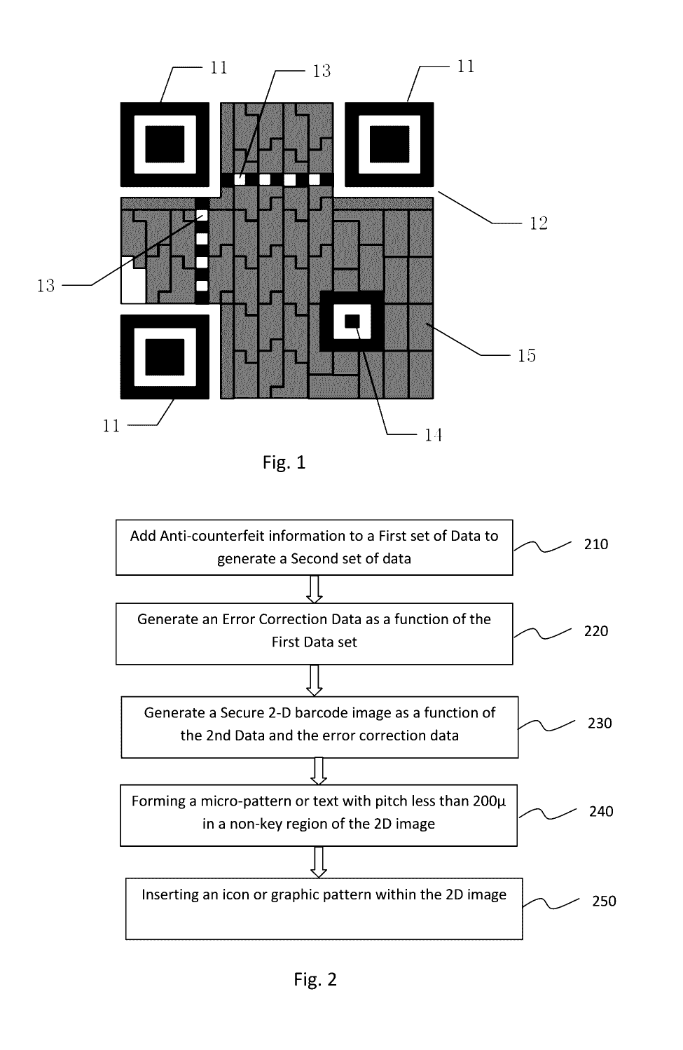

FIG. 1 shows a schematic diagram of a 2-D code;

FIG. 2 shows a flow diagram of a 2-D code generating method according to the embodiments of the present disclosure;

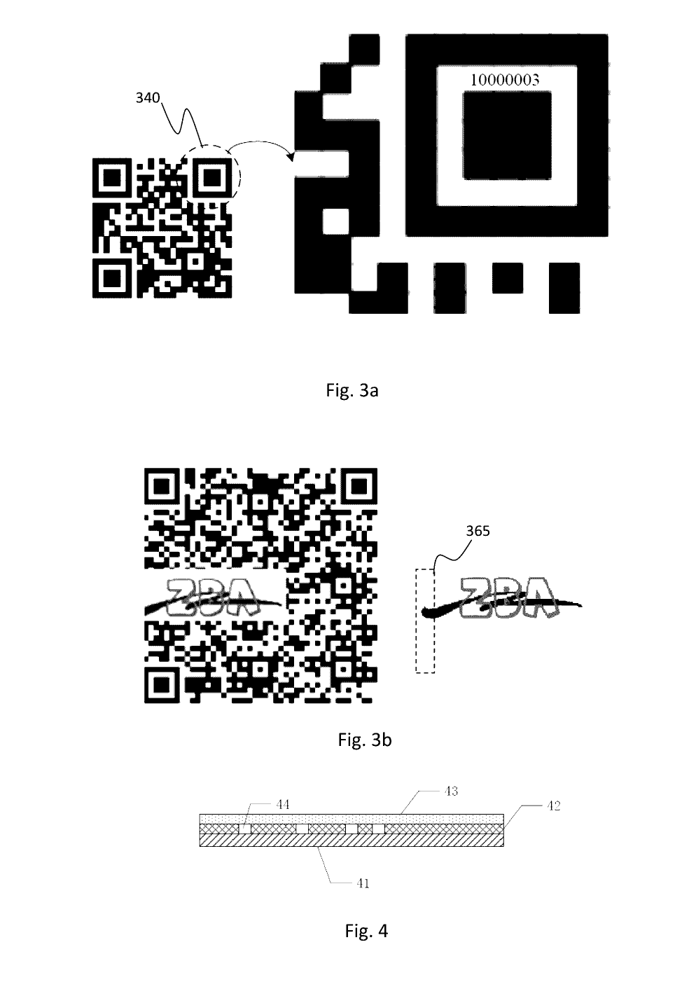

FIG. 3a shows a schematic diagram of a 2-D code added with microtext, which is generated according to the embodiments of the present disclosure;

FIG. 3b shows a schematic diagram of a 2-D code added with an icon, which is generated according to the embodiments of the present disclosure;

FIG. 4 shows a cross-sectional diagram of an anti-counterfeit label according to the embodiments of the present disclosure;

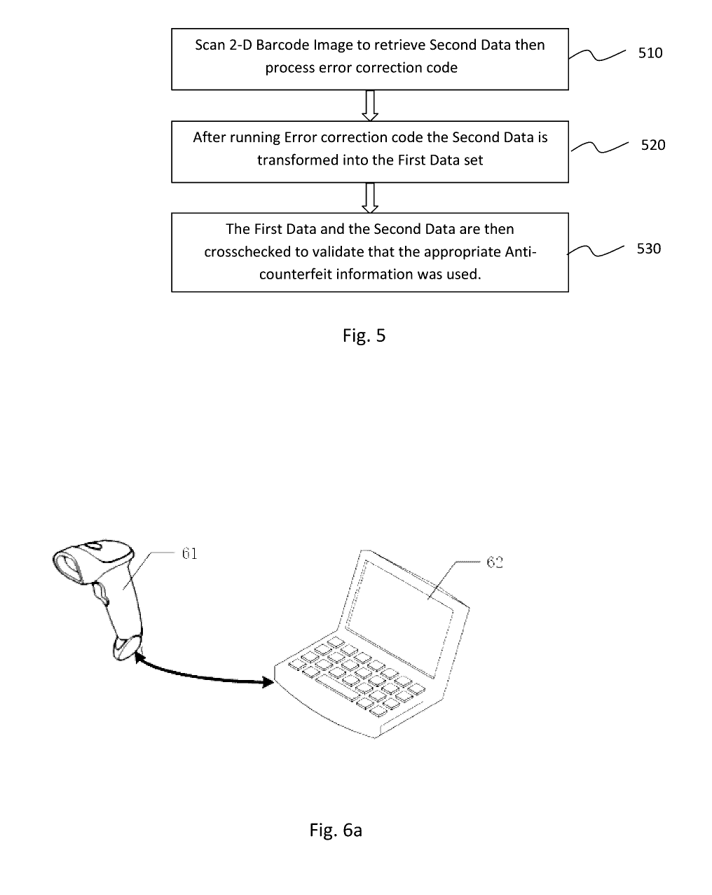

FIG. 5 shows a flow diagram of a 2-D code detecting method according to the embodiments of the present disclosure;

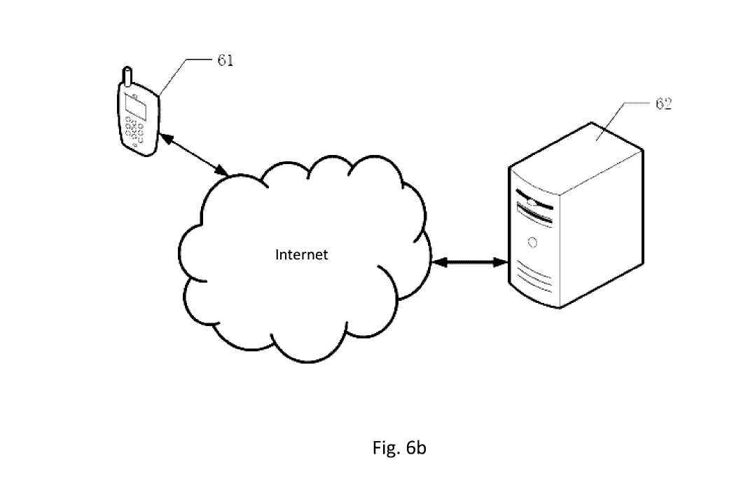

FIG. 6a shows a schematic diagram of a 2-D code detecting apparatus according to the embodiments of the present disclosure;

FIG. 6b shows a schematic diagram of a further 2-D code detecting apparatus according to the embodiments of the present disclosure;

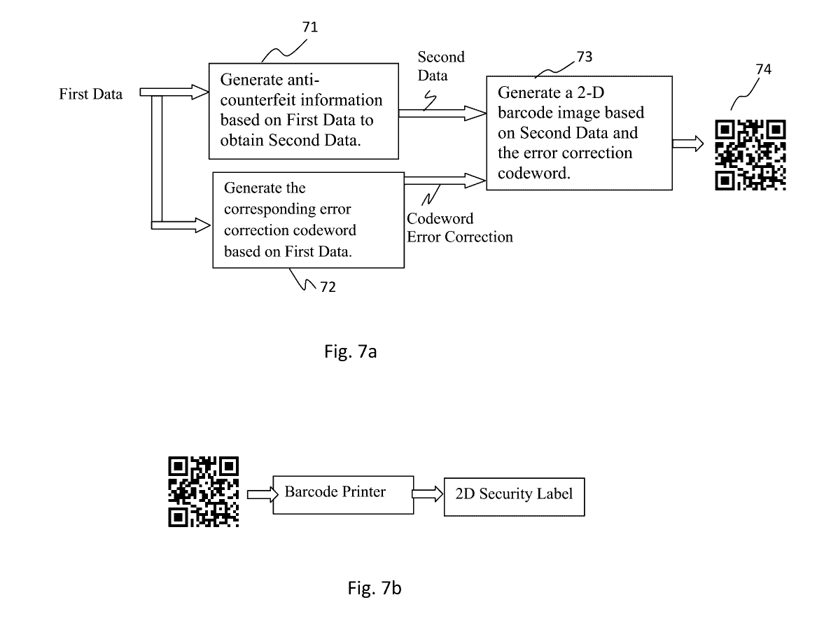

FIG. 7a shows a modular schematic diagram of a 2-D code generating apparatus implemented with a computer program according to the embodiments of the present disclosure;

FIG. 7b shows in block form the 2-D bar code image fed to a bar code printer to form a corresponding 2-D security label;

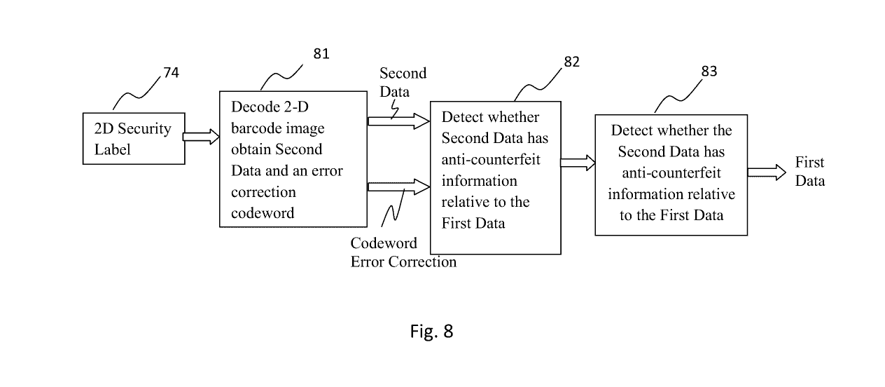

FIG. 8 shows a modular schematic diagram of a 2-D code detecting apparatus implemented with a computer program according to the embodiments of the present disclosure;

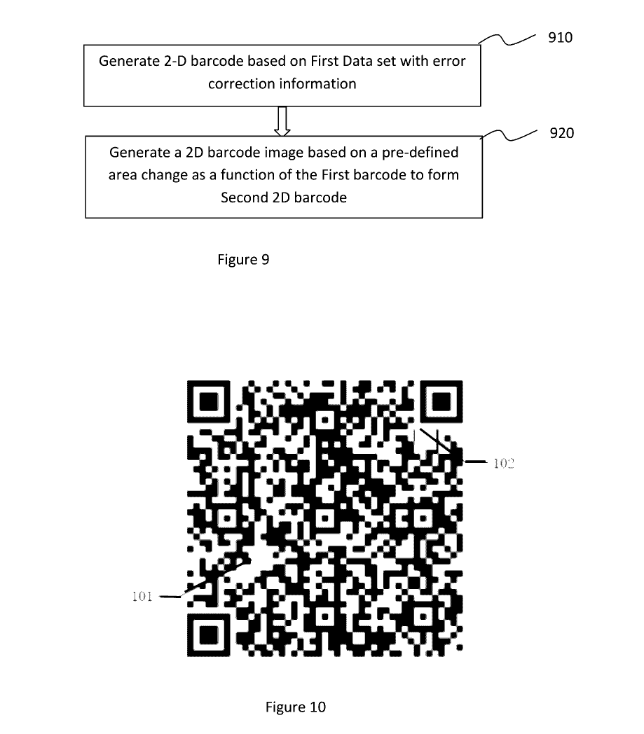

FIG. 9 shows a flow diagram of a 2-D code generating method according to the embodiments of the present disclosure;

FIG. 10 shows a schematic diagram of a 2-D code generated according to the embodiments of the present disclosure;

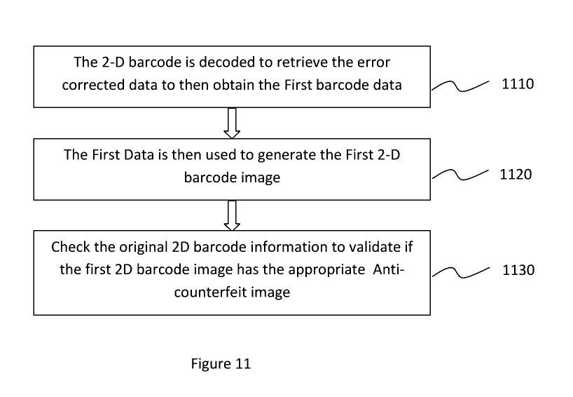

FIG. 11 shows a flow diagram of a 2-D code detecting method according to the embodiments of the present disclosure;

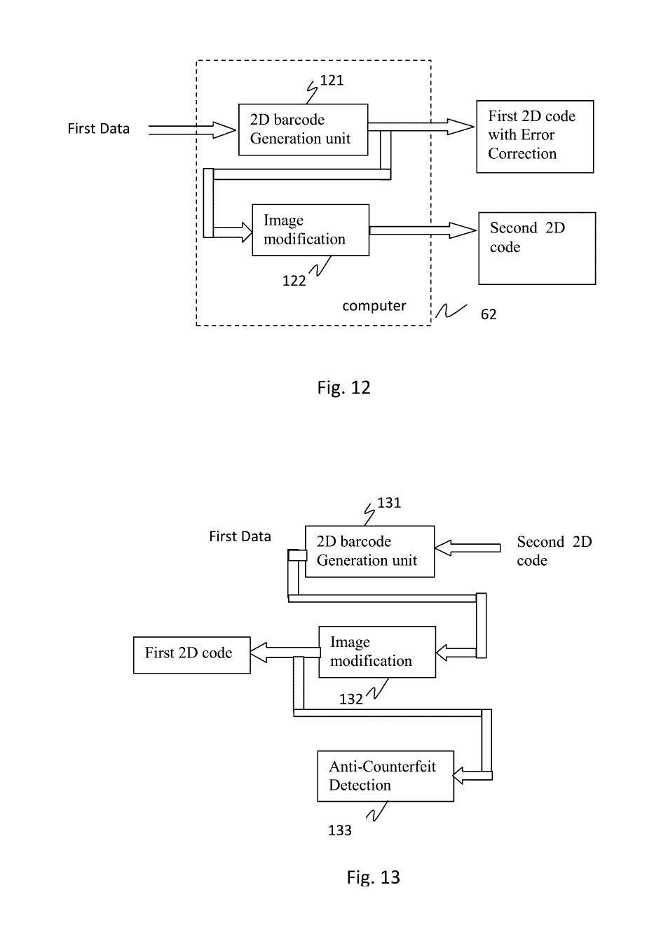

FIG. 12 shows a modular schematic diagram of a 2-D code generating apparatus implemented with a computer program according to the embodiments of the present disclosure; and

FIG. 13 shows a modular schematic diagram of a 2-D code detecting apparatus implemented with a computer program according to the embodiments of the present disclosure.

### DETAILED DESCRIPTION OF THE PREFERRED EMBODIMENTS

Hereinafter, the present disclosure will be described based on the embodiments. However, the present disclosure is not limited to these embodiments. In the detailed description of the present disclosure hereinafter, some specific details will be described extensively. For those skilled in the art, the present disclosure may be thoroughly understood without description of these details. In order to avoid confusing the substance of the present disclosure, known methods, processes, flows, elements and circuits will not be described in detail.

In addition, a person of normal skill in the art should understand the drawings provided here are for illustrative purposes, and the drawings are not necessarily drawn in proportion and to scale.

Unless explicitly required in the context, the terms “comprise” and “include” and like expressions in the entire description and claims should be interpreted as an inclusive meaning, not an exclusive or exhaustive meaning; in other words, they mean “include, but not limited to.”

In the description of the present disclosure, it should be understood that the terms “first” and “second” are only for descriptive purposes, and cannot be understood as indicating or implying relative importance. In addition, in the description of the present disclosure, unless otherwise indicated, the meaning of “plural” is two or more.

The 2-D code uses a concept of a binary bit stream in the aspect of code compilation, where a plurality of geometric forms corresponding to the binary are used to indicate textual numerical information, such that the machine (computer) may identify encoded content. Based on the encoded form, the 2-D code may be divided into a stacked type/row-arranged type 2-D code and a matrix-type 2-D code. The stacked type/row-arranged type 2-D code is also referred to as a piled type 2-D code or layer-arranged type 2-D code, whose encoded principle is established by piling a one-dimensional bar code into two or multiple rows as required. The existing stacked type/row-arranged type 2-D codes include: Code 16K code, Code 49 code, PDF417 code, Micro PDF417 code, etc. The matrix-type 2-D code is encoded in a rectangular space through alternating distribution of black and white pixels. At corresponding element positions of the matrix, appearance of dots (square dots, round dots or other shapes) represents “1,” while non-appearance of dots represents a binary “0.” The existing matrix-type 2-D code includes: QR code (quick response code), Maxi code (Maxicode), and data matrix (Data Matrix). No matter what form is used to encode, the 2-D code generally has an error correction mechanism, and can perform error correction for an image loss or change caused by stain or wear, which guarantees the correctness of reading.

Hereinafter, the embodiments of the present disclosure will be illustrated with the QR code as an example. However, those skilled in the art can understand that the method and apparatus according to the embodiments of the present disclosure may be applied to other 2-D code encoding types having an error correction mechanism.

FIG. 1 shows a schematic diagram of a composition of a 2-D code. FIG. 1 shows a layout of a QR code. The QR code is usually accommodated in a rectangular region. The QR code comprises position sounding graphs 11 at an angle position of the rectangular region, separators 12 surrounding the position sounding graphs, positioning graphs 13 connected between the position sounding graphs, and correcting graphs 14 distributed within the rectangular region. Besides, the QR code further comprises a codeword 15 composed of a black and white pixel, distributed in a region not filled with the above functional patterns so as to characterize the data characterized by the QR code. For the QR code, the prior art performs error correction through different mechanisms. Generally speaking, mainly by forming the data to be characterized into a binary number, the error correction codeword for the binary number is then calculated based on the error correction algorithm, and the error correction codeword and the corresponding binary number are formed into a codeword composed of black and white pixels in a specific form, and then a QR code is generated on that basis. This kind of QR code will comprise a data codeword portion and an error correction codeword portion in the graph.

In the prior art, some technologies will partition the binary number corresponding to the to-be-characterized data into a plurality of portions, and then corresponding error correction codewords are obtained by performing calculation on each portion, and the error correction codeword and corresponding binary number are connected and subjected to the mask calculation to obtain a data sequence with an error correction codeword; finally, a plurality of data sequences are connected to form a codeword composed of a black and white pixel, and on this basis, a QR code is generated.

Based on the error correction feature of the 2-D code, the embodiments of the present disclosure provide a 2-D code generating method for adding an anti-counterfeit function for a 2-D code. Generally speaking, the 2-D code generating method according to the embodiments of the present disclosure generates a 2-D code image having error correction data and anti-counterfeit information based on first data and anti-counterfeit information, wherein the first data and/or corresponding 2-D code image are modified in a predetermined manner to add the anti-counterfeit information, and cause the 2-D code image having error-correction data and anti-counterfeit information to be decoded into the first data based on the error correction data. The first data is data that was originally to be characterized by the 2-D code, which may be a number, an alphabet, a 8-bit byte, a Chinese character or a Japanese character, etc.

FIG. 2 shows a flow diagram of a 2-D code generating method according to the embodiments of the present disclosure. As shown in FIG. 2, the method comprises:

Step 210: adding anti-counterfeit information in, or to, a first set of data to obtain a second set of data.

In this step, the anti-counterfeit information is additional information added according to a predetermined rule, as long as the computer can identify that it is not a portion of the first data.

Specifically, step 210 may replace at least one-bit data at a predetermined position in the first data with predetermined data or data obtained according to a predetermined rule.

For example, the first data is “12345,” the anti-counterfeit information is a numerical value obtained by the fourth-bit digit minus 1 (i.e., “3” in this example). The operation of adding the anti-counterfeit information replaces the fourth bit of the first data as the anti-counterfeit information, then the second data obtained after the anti-counterfeit information is added is “12335.” Subsequently, whether anti-counterfeit information exists or not is detected by detecting the data at the fourth bit of the second data and the data at the fourth bit of the first data.

For another example, the first data is “12345,” and the first data is a numeric sequence; the anti-counterfeit information is a predefined character “$.” An operation of adding anti-counterfeit information is to replace the fourth bit of the first data as the predefined character “$.” Accordingly, the second data obtained after adding the anti-counterfeit information is “123$5.” Subsequently, as long as “$” is detected at the fourth bit of the second data, it indicates that anti-counterfeit information exists.

Meanwhile, step 210 may also add predetermined data or data obtained according to a predetermined rule at a predetermined position in the first data.

For example, the first data is “12345,” the anti-counterfeit information is a predetermined character “$.” The operation of adding the anti-counterfeit information is adding the predetermined character “$” at the end of the number sequence. Therefore, the second data obtained after the anti-counterfeit information is “12345$.” Subsequently, as long as “$” is detected at the end of the second data, it indicates that the anti-counterfeit information exists.

As another example, assume the first data is “12345,” and the anti-counterfeit information is a difference between the last number and the first number of the number sequence (i.e., the “5” minus the “1” in the present example for a value of “4”). The operation of adding the anti-counterfeit information is adding (or subtracting) the anti-counterfeit information at the location indicated by the value of the calculated information. Continuing in the above example the anti-counterfeit value of “4” would indicate that 4th digit (which in this particular instance is a 4) would have the first digit subtracted from its value. This would yield a value of three which would then yield the second data of “12335.” Subsequently, whether the anti-counterfeit information exists may be detected by detecting the second data and reversing to process and then comparing with the first data which has been calculated using the error correction codeword.

The above illustrations were made with examples of operating by modifying only one-bit number or character. It should be understood that subject to guaranteeing that the error ratio of the second data relative to the first data is within the error correctable scope, an operation on multi-bit data may be performed so as to add more complicated anti-counterfeit information.

Meanwhile, the illustration has been made above with an example of directly operating the decimal data or character data. It should be understood that the above operation of adding and/or replacing may also be performed after the first data is converted into a binary (i.e., performing a binary operation on the first data in a binary form).

Meanwhile, the above anti-counterfeit information may also be enciphered information.

Step 220, a corresponding error correction codeword is generated based on the first data.

In this step, an error correction codeword is generated based on the first data desired to be presented by the 2-D code. Therefore, when performing computer identification subsequently using a common 2-D code detecting apparatus, the computer may identify and obtain second data and an error correction codeword corresponding to the first data based on a data codeword portion of the 2-D code. The computer may obtain the first data through error correction based on the error correction mechanism.

Step 230, a 2-D code image is generated based on the second data and the error correction codeword.

In this step, based on the existing 2-D code generating method, the above error correction code acts as the error correction code for the second data to combine the two and convert them into a 2-D code in an image form.

The 2-D code obtained through the above step [i.e., step 230] has an anti-counterfeit function. By utilizing the self-correction function of the 2-D code, when detected by a normal 2-D code detecting apparatus, the data added with the anti-counterfeit information will be corrected to identify data without anti-counterfeit information desired to be presented by the manufacturer, while when the data are detected by a 2-D code detecting apparatus having an anti-counterfeit function, the anti-counterfeit information will be detected based on the uncorrected second data, thereby identifying the authenticity of the identification quickly and simply.

Preferably, the 2-D code generating method according to the present embodiment may also comprise a step of further enhancing its anti-counterfeit performance.

For example, the 2-D code generating method may also comprise:

Step 240, forming a micro pattern or a micro text with a pixel pitch of less than 200 microns in a non-key region (e.g., 340) of the 2-D code image.

Wherein, the non-key region (e.g., 340) refers to a region which does not affect normal decoding of the 2-D code. The non-key region may be a region such as a position detection graph, or a region where the spacer is located, etc. As shown in FIG. 3a, the micro text (e.g., 10000003 in FIG. 3a) or micro pattern is formed within a region of the position detection graph, which may be a hollowed-out pattern or a metal pattern.

Because the minimum pixel pitch which can be identified by a human eyes is about 200 microns, a micro pattern or micro text with a pixel pitch of less than 200 microns cannot be identified by human eyes. Meanwhile, the current processing technology may implement addition of micro patterns or micro text with a pixel pitch of less than 200 microns in the pattern (i.e., the micro patterns or micro texts unidentifiable by human eyes). Because these micro patterns or micro texts will not be easily detected by a counterfeiter, or the manufacturing technology is not understood by a counterfeiter, they serve to provide an anti-counterfeit function.

For example, micro patterns or micro texts may be formed on a thin film having a transparent substrate and a metal layer through a laser etching process. Specifically, in a holographic film, the thickness of the metal layer is usually less than 1 to 3 microns. Using a laser beam with a lower energy, the metal layer may be evaporated to expose part of the base layer, thereby patterning the metal layer. Existing laser engraving machines may be accurately controlled by a controller and the power and beam width of the laser (namely, the diameter of the irradiation point of the laser beam) is also controlled. Therefore, the metal layer may be subjected to a high-precision etching operation using existing laser engraving machines. Based on the laser etching process, other parts forming the 2-D code may be formed by simultaneously engraving on the metal layer based on the laser etching process.

The 2-D code generating method may also comprise:

Step 250, inserting an icon (e.g., ZBA) visible to the naked eye in the 2-D code.

As shown in FIG. 3b, content of the 2-D code may be enriched by adding an icon (e.g., ZBA). In addition, an icon after being anti-counterfeit processed [e.g., the purposely pre-truncated portion (e.g., 365) shown in FIG. 3b] may also have a further anti-counterfeit function.

FIG. 4 shows a structural diagram of an anti-counterfeit label according to the embodiments of the present disclosure. As shown in FIG. 4, the anti-counterfeit label comprises a base 41 and a graphic layer 42. The graphic layer is located above the base and patterned to form the 2-D code having an anti-counterfeit function as generated according to the above method. Specifically, the graphic layer is preferably a metal layer. Through the laser etching process above, the metal layer may be patterned to form a desired pattern, text, and micro pattern/micro text.

The 2-D code with an anti-counterfeit function as generated according to the above method is formed on the anti-counterfeit label, such that the above anti-counterfeit technology may be conveniently applied to various products that need anti-counterfeit.

Meanwhile, the metal layer may also be pre-molded to form a holographic anti-counterfeit pattern so as to further enhance its anti-counterfeit performance.

Preferably, the anti-counterfeit label may also comprise a protective layer 43 overlying the graphic layer 42. The protective layer 43 is generally a transparent thin layer. Because the principle of laser engraving or etching lies in absorbing the energy of the laser after the engraved or ablated surface material contacts the laser, the structure between molecules or atoms of the material will be damaged due to excitation, and the molecules or atoms of the material absorbing the laser energy will be gasified and escaped. For the laser holographic film having a protective layer 43, by adjusting the waveband and pulse of the laser, the protective layer 43 may transmit the laser, and the laser will be absorbed by the metal layer 42 below the protective layer 43. When the power of the laser is relatively small, the metal layer 42 will be gasified due to excitation after absorbing substantially all laser energy (the gasification is not caused by temperature rise); the gasified metal atom escapes through the protective layer 43. Because the temperature is controllable during the process of the metal layer being etched, under the condition that the protective layer 43 is kept undamaged physically, the metal layer 42 there underneath may be patterned. For example, when the metal layer 42 is an aluminum layer, a semiconductor laser using an infrared waveband may be used to etch the metal layer 42, which may guarantee that the PVC protective layer 43 will not be damaged. After being etched with the above method, a hollowed-out structure 44 is formed on the metal layer 42, while the base layer 41 and the protective layer 43 are kept substantially intact.

Therefore, the difficulty of counterfeit may be further increased by combining the anti-counterfeit technology of the 2-D code and the anti-counterfeit technology of the laser holographic film, thereby enhancing the anti-counterfeit performance.

FIG. 5 shows a flow diagram of a method of detecting a 2-D code according to the embodiments of the present disclosure. As shown in FIG. 5, the 2-D code detecting method comprises:

Step 510: obtaining second data and an error correction codeword based on a 2-D code image.

As mentioned above, when generating a 2-D code, a 2-D code is generated based on the second data with anti-counterfeit information and an error correction codeword corresponding to the original data (i.e., first data). A 2-D code image may be obtained by scanning a label with the 2-D code by an image acquiring means or an optical recognition means, further decoding the 2-D code image may result in the second data and the error correction codeword corresponding to the original data (i.e., first data).

Step 520: performing error correction to the second data based on the error correction codeword to obtain the first data.

In accordance with a standard flow of performing machine recognition to the 2-D code, the error correction codeword is regarded to correspond to the second data; therefore, error correction may be performed to the second data based on the error correction codeword. Because it is the first data that actually corresponds to the error correction codeword, as long as the error between the second data and the first data is within a correctable range, the second data will be corrected to the first data in the error correction step. A normal 2-D code detecting apparatus generally ends the detection flow after the error correction is completed, and meanwhile the detection result is outputted (i.e., first data obtained through error correction).

Therefore, when recognizing the above 2-D code using a common 2-D code recognizing apparatus, it will not be found that the 2-D code carries the anti-counterfeit information, let alone knowing what the anti-counterfeit information is.

The 2-D code detecting method according to the embodiments of the present disclosure further comprises:

Step 530: detecting whether the second data has anti-counterfeit information with respect to the first data.

As mentioned above, the second data is added with the counterfeit information, which may be substitution of at least one-bit data of the first data, or addition of information at a predetermined position of the first data. Therefore, by comparing the difference between the second data and the first data and determining whether the difference information is information in tally with a predetermined anti-counterfeit rule, it may be identified whether the 2-D code is a counterfeit.

For example, the second data is “12335,” and meanwhile the first data is “12345.” The second data is detected to find that the fourth bit of the first data is replaced by a value of the original number minus one. This complies with a predetermined anti-counterfeit rule. Therefore, the second data has anti-counterfeit information. Therefore, it may be determined that the 2-D code is not a counterfeit.

Specifically, based on the difference in the anti-counterfeit information adding manner, the step 530 may comprise:

Detecting whether data at at least one predetermined position in the first data is replaced with predetermined data or data obtained according to the predetermined rule.

Step 530 may also comprise:

detecting whether predetermine data or data obtained according to a predetermined rule is added at at least one predetermined location in the first data.

Therefore, through the above detecting method, anti-counterfeit information that cannot be detected according to a common 2-D code detection flow may be detected.

By utilizing the self-correction function of the 2-D code, when being detected by the common 2-D code detecting apparatus, the data added with the anti-counterfeit information will be corrected to identify data without the anti-counterfeit information desired to be presented by the manufacturer, while when the data are detected by the 2-D code detecting apparatus having an anti-counterfeit function, the anti-counterfeit information will be detected based on the uncorrected second data, thereby identifying the authenticity of the identification quickly and conveniently.

The above 2-D (i.e., 2-D) code detecting method needs a specific 2-D code detecting apparatus to perform. FIG. 6a shows a schematic diagram of a 2-D code detecting apparatus according to the embodiments of the present disclosure. As shown in FIG. 6a, the 2-D detecting apparatus comprises an image obtaining means 61 and a data processing means 62. While the images show what looks like a conventional commercially available bar code scanner, there are changes to the data processing of the bar code image that will allow the system to determine whether the bar code is a valid or counterfeit label. The error correction function used as part of the 2-D code specification is used to generate the first data from the scanned image. This is how a conventional bar code scanner would correct for a damaged code. However, in the instant case since the bar code has been intentionally altered in a controlled manner, we use an intermediate step to interrogate the data to determine if the counterfeit information is consistent with the specific alteration.

The image obtaining means 61 is for scanning a 2-D code to obtain a 2-D code image. It may be a scanning gun as shown in FIG. 6a or a camera device as shown in FIG. 6b or a terminal device with a camera device (e.g., a mobile communication terminal, a laptop, a portable computer, etc.).

The data processing means 62 is configured to perform instructions including the following operations:

obtaining first data and an error correction codeword based on the 2-D code image; obtaining second data by performing error correction processing to the first data based on the error correction codeword; and detecting whether the second data has anti-counterfeit information relative to the first data.

The image obtaining means 61 is connected to the data processing means 62 via a bus or a wireless/wired communication, wherein the wireless/wired communication connection may be a short-range distance connection via a local area network or a remote connection based on the Internet.

Specifically, as shown in FIG. 6a, the scanning gun 61 may be connected via a general computer 62 for example through a universal serial bus (USB), the general computer 62 performs anti-counterfeit detection based on the 2-D code image obtained by the scanning gun 61.

For another example, as shown in FIG. 6b, the image obtaining means 61 is a mobile terminal with a camera device, while the data processing means 62 is a remotely disposed server. The mobile terminal 61 is accessed to the Internet via a local area network or a mobile access network and is communicatively connected to the remotely disposed server 62 through network. Through the communicative connection, the mobile terminal 61 may transmit the 2-D code image obtained by scanning to the server 62. The server 62 performs an anti-counterfeit operation based on the stored computer program, and may return the result of anti-counterfeit detection to the mobile terminal via the network. Therefore, obviating a need of modifying the mobile terminal program, a human-machine interaction for obtaining the 2-D code may be provided based on a Web page or other common mobile terminal software interface (Wechat, Weibo, twitter, etc.) through a remotely disposed server.

The data processing means 62 may be any means configured to perform a data processing instruction by running a program, which may be formed into various terminal forms such as a personal computer, a server, a laptop computer, a tablet computer, a digital media player, an intelligent mobile communication terminal and the like or integrated with the image obtaining means 61 into a whole in a manner of a specific module.

A typical data processing means 62 may comprise a bus, and a processor, volatile memory (internal storage), and a non-volatile memory which are connected to the bus, wherein the processor may be configured to perform the above instructions. The data processing means 62 may also comprise an input/output (I/O) device configured to interact with the user, obtain, and feedback information. In the embodiments of the present disclosure, the input/output (I/O) device may be used to feedback whether the anti-counterfeit information is detected to the user, which may be fed back through a signal light, or a speaker, or a display device, as an example.

The data processing means may also be a remote computing device (e.g., a server) for obtaining a 2-D code image from the image obtaining means 61 via the Internet, and by running a program that performs an operation of detecting anti-counterfeit information, detection of the anti-counterfeit information may be performed based on the obtained 2-D code image.

FIG. 7 shows a modular schematic diagram of a 2-D code generating apparatus implemented with a computer program according to the embodiments of the present disclosure. As shown in FIG. 7, the 2-D code generating apparatus implemented with a computer program comprises an anti-counterfeit information adding unit 71, an error correction codeword generating unit 72, and a 2-D code generating unit 73;

wherein, the anti-counterfeit information adding unit 71 is configured to add anti-counterfeit information in first data to obtain second data.

The error correction codeword generating unit 72 is configured to generate a corresponding error correction codeword based on the first data.

The 2-D code generating unit 73 is configured to generate a 2-D code image 74 based on the second data and the error correction codeword as shown in FIG. 7a. The 2-D code image 74 can then be supplied to a bar code printer 76 to produce a corresponding 2-D security label as shown in FIG. 7b.

FIG. 8 shows a modular schematic diagram of a 2-D code generating apparatus implemented with a computer program according to the embodiments of the present disclosure. As shown in FIG. 8, the 2-D code detecting apparatus implemented with a computer program comprises an image decoding unit 81, an error correcting unit 82, and an anti-counterfeit detecting unit 83,

wherein, the image decoding unit 81 is configured to obtain second data and an error correction codeword based on a 2-D code image.

the error correcting unit 82 is configured to detect whether the second data has anti-counterfeit information relative to the first data.

the anti-counterfeit detecting unit 83 is configured to detect whether the second data has anti-counterfeit information relative to the first data.

By utilizing the self-correction function of the 2-D code, when the data added with anti-counterfeit information are detected by a normal 2-D code detecting apparatus, it will be corrected to identify data without anti-counterfeit information desired to be presented by the manufacturer, while when the data are detected by a 2-D code detecting apparatus having an anti-counterfeit function, the anti-counterfeit information will be detected based on the uncorrected second data, thereby identifying the authenticity of the identification quickly and simply.

On the other hand, the anti-counterfeit information may also be added by directly modifying the 2-D code image corresponding to the first data.

FIG. 9 shows a flow diagram of a 2-D code generating method according to the embodiments of the present disclosure. as shown in FIG. 9, the 2-D code generating method comprises:

Step 910, generating a corresponding first 2-D code image having error correction data based on the first data.

In this step, an error correction code is generated based on the first data directly according to the existing 2-D code image generating manner, and a corresponding first 2-D code image is generated based on the first data and the error correction code.

The first 2-D code image according to the present embodiment is a normal 2-D code image, and the first data may be obtained by decoding it.

Step 920, modifying at least one region of the first 2-D code image in a predetermined manner so as to obtain a second 2-D code image.

Wherein, the modifying is kept within a predetermined limit such that the second 2-D code image can be decoded into the first data based on the error correction data, and the modifying is performed without changing an original image pattern in the corresponding region.

In the embodiments of the present disclosure, that the modifying is performed without changing an original image pattern in the corresponding region means the modification only changes the distribution manner of the original image, without causing the appearance form of the image to change, e.g., the original image pattern is distribution of black pixels and white pixels according to a certain rule; the modified image is still distribution of black pixels and white pixels, just with a different distribution rule. In this way, it is still hard to tell whether the 2-D code has been artificially modified by naked eyes.

Specifically, in step 920, pixels of at least two predetermined positions of the first 2-D code image are changed to a predetermined color. Because the error correction mechanism of the 2-D code may guarantee error correction of 30% codewords at the highest. Therefore, the pixels at a part of predetermined positions are modified, which will not affect subsequent decoding and correcting the second 2-D code image to the first data, i.e., obtaining data desired to be carried by the second 2-D code image.

Meanwhile, modification of pixels at a part of positions to “black” or “white,” particularly the modification to the codeword part, will cause it impossible to find by naked eyes that the second 2-D code is a 2-D code with information added. Therefore, the anti-counterfeit information in the second 2-D code cannot be detected or is hard to be detected by a common 2-D code detecting apparatus and naked eyes. Only a specific 2-D code detecting apparatus may compare, after decoding, whether the difference between the first 2-D code and the second 2-D code matches the setting rule of the anti-counterfeit information. Therefore, the generated 2-D code image has a strong anti-counterfeit function.

FIG. 10 is a schematic diagram of a 2-D code generated in accordance with the invention. At first glance it does not seem different than common 2-D code. However, the 2-D code image as shown in FIG. 10 will set selected (or all) the pixels within a selected region or location 101 (also referred to as a region 101) and location 102 (the above locations are only exemplary illustration) to be white. This forms an error regarding the 2-D code shown in FIG. 10, the pixel error between position 101 and position 102 may be corrected by an error correction mechanism or an error correction data such that it may be decoded and first data may be restored (i.e., corrected). When performing anti-counterfeit information detection, by detecting the difference between the 2-D code image and the 2-D image corresponding to the first data, it may be found that position 101 and position 102 are modified to be white, which conforms to a predetermined anti-counterfeit information modification rule. Therefore, it may be known that the 2-D code has anti-counterfeit information.

The modified position or region may be designed as desired so as to make the modification carry more information.

Of course, those skilled in the art may understand that other manners may be used, e.g., modifying the first 2-D code by artificially making a pattern or flag similar to stain or wear.

Preferably, the anti-counterfeit performance of the 2-D code image may also be further enhanced using various manners above, for example, forming a micro pattern or a micro text forming a pixel pitch less than 200 microns in the 2-D code non-key region, and inserting an icon visible by naked eyes in the 2-D code.

Moreover, based on the laser etching technology, a 2-D code image generated based on the above method may be manufactured into an anti-counterfeit label.

Meanwhile, the above method of modifying the 2-D code image to set anti-counterfeit information may be combined with a method of setting the anti-counterfeit information in the first data, thereby further enhancing the anti-counterfeit performance.

Correspondingly, FIG. 11 is a flow diagram of a 2-D code detecting method according to the embodiments of the present disclosure. As shown in FIG. 11, the 2-D code detecting method comprises:

Step 1110, performing decoding and error correction based on the original 2-D code image to obtain first data.

In this step, the obtained original 2-D code image is subjected to decoding and error correction according to the prior art. When the scanned 2-D code image is a 2-D code image with anti-counterfeit information, the original 2-D code image is the above second 2-D code image; otherwise, it is also possible a counterfeited 2-D code image or common 2-D code image. Regardless of which kind of 2-D code information, the data (namely, first data) carried thereby may be obtained after decoding and error correction in the step.

Step 1120, obtaining a corresponding first 2-D code image based on the first data.

In this step, a corresponding 2-D code image (i.e., first 2-D code image) is re-generated based on the first data. If parameters such as a reference code manner are needed, the generating process may proceed based on the parameters obtained when decoding is performed in step 1110. Therefore, the 2-D code image without any counterfeit information, which carries the first data, may be obtained.

Step 1130, detecting whether the original 2-D code image has anti-counterfeit information with respect to the first 2-D code image.

By comparing the original 2-D code image and the first 2-D code image, it may be detected whether a difference exists therebetween; if the difference exists, it is determined whether the difference is consistent with a predetermined anti-counterfeit information modification rule; in the case of consistency, it indicates that anti-counterfeit information is set in the original 2-D code image, and then the 2-D code image is not a counterfeit. Otherwise, it might be a counterfeit 2-D code image.

Because the 2-D code has a higher error correction ratio, after setting the counterfeit information by modifying the 2-D code image, even the image has certain stain and wear, it may be still recognized normally; meanwhile, because the anti-counterfeit information is set according to a predetermined rule, the stain and wear generally will not affect detection of the anti-counterfeit information.

Specifically, step 1130 may be: detecting whether the original 2-D code image modifies pixels at at least two predetermined positions to a predetermined color relative to the first 2-D code image.

Of course, it would be easily understood that under the condition of setting the anti-counterfeit information with other modification manner, step 1130 will adaptively change.

The 2-D code generating method and the 2-D code detecting method according to the embodiments of the present disclosure may be implemented by a general computing device, wherein the 2-D code detecting method may be performed based on the 2-D code detecting apparatus with the architecture of FIG. 6a or 6b or an equivalent structure.

FIG. 12 shows a modular schematic diagram of a 2-D code generating apparatus implemented with a computer program according to the embodiments of the present disclosure. As shown in FIG. 12, the 2-D code generating apparatus implemented with the computer program comprises a 2-D code image generating unit 121 and an image modifying unit 122.

The 2-D image generating unit 121 is for generating a corresponding first 2-D code image having error correction data based on the first data.

The image modifying unit 122 is for modifying at least one region of the first 2-D code image in a predetermined manner to obtain a second 2-D code image.

wherein the modifying is kept within a predetermined limit such that the second 2-D code image can be decoded into the first data based on the error correction data, and the modifying is performed without changing an original image pattern in the corresponding region.

Specifically, the image modifying unit 122 is for modifying the pixels at at least two predetermined positions of the first 2-D code image to a predetermined color.

FIG. 13 shows a modular schematic diagram of a 2-D code detecting apparatus implemented with a computer program according to the embodiments of the present disclosure. As shown in FIG. 13, the 2-D code detecting apparatus implemented with the computer program comprises an image parsing unit 131, an image generating unit 132, and an anti-counterfeit detecting unit 133.

wherein, the image parsing unit 131 is for performing decoding and error correction based on the original 2-D code image to obtain first data.

The image generating unit 132 is for obtaining a corresponding first 2-D code image based on the first data.

The anti-counterfeit detecting unit 133 is for detecting whether the original 2-D code image has anti-counterfeit information relative to the first 2-D code image.

By utilizing the self-correction function of the 2-D code, when the data added with anti-counterfeit information are detected by a normal 2-D code detecting apparatus, it will be corrected to identify data without anti-counterfeit information desired to be presented by the manufacturer, while when the data are detected by a 2-D code detecting apparatus having an anti-counterfeit function, the anti-counterfeit information will be detected based on the uncorrected second data, thereby identifying the authenticity of the identification quickly and simply.

Apparently, those skilled in the art should understand that respective modules or respective steps of the present disclosure may be implemented by a general computing device; they may be centered on a single computing device or distributed on a network composed of a plurality of computing devices; optionally, they may be implemented by a computer-executable program code, such that they may be stored in a memory so as to be executed by a computing device, or they may be made into respective integrated circuit modules, or a plurality of modules or steps therein may be made into a single integrated circuit module for implementation. In this way, the present disclosure is not limited to combination of any specific hardware and software.

The embodiments described above are for purpose of illustration and are not intended to limit the scope of the invention. To those skilled in the art, the present disclosure may have various alternations and changes. Any modifications, equivalent replacements, and improvements made within the spirit and principle of the present disclosure should be included within the protection scope of the present disclosure.

What is claimed is:

1. A two-dimensional (2-D) code generating method, comprising:
generating a 2-D code image having error correction data and anti-counterfeit information based on first data and anti-counterfeit information;
wherein the first data and/or corresponding 2-D code image are modified in a predetermined manner to add the anti-counterfeit information, the modifying having a predetermined limit such that the 2-D code image having error correction data and anti-counterfeit information can be decoded into the first data based on the error correction data.

2. The 2-D code generating method according to claim 1, characterized that the generating a 2-D code image having error correction data and anti-counterfeit information based on first data and anti-counterfeit information comprises:
generating a corresponding first 2-D code image having error correction data based on the first data;
modifying at least one region of the first 2-D code image in a predetermined manner to obtain a second 2-D code image;
wherein the modifying is kept within a predetermined limit such that the second 2-D code image can be decoded into the first data based on the error correction data, and the modifying is performed without changing an original image pattern in the corresponding region.

3. The 2-D code generating method according to claim 2, characterized in that the modifying the first 2-D code image in a predetermined manner to obtain a second 2-D code image comprises:
modifying pixels at at least two predetermined locations of the first 2-D code image to a predetermined color.

4. The 2-D code generating method according to claim 1, characterized in that the generating a 2-D code image having error correction data and anti-counterfeit information based on first data and anti-counterfeit information comprises:
adding anti-counterfeit information in the first data to obtain second data;
generating a corresponding error correction codeword based on the first data; and
generating a 2-D code image based on the second data and the error correction codeword.

5. The 2-D code generating method according to claim 4, characterized in that the adding anti-counterfeit information in the first data to obtain second data comprises:
replacing at least one-bit data at a predetermined location in the first data with predetermined data or data obtained according to a predetermined rule; or
adding predetermined data or data obtained according to a predetermined rule at a predetermined location in the first data.

6. The 2-D code generating method according to claim 4, characterized in that the anti-counterfeit information and/or the first data are encrypted data.

7. The 2-D code generating method according to claim 1, characterized in that the method further comprises:
forming a micro pattern or a micro pattern or a micro text with a pixel pitch of less than 200 microns in a non-key region of the 2-D code image.

8. The 2-D code generating method according to claim 6, characterized in that the method further comprises:
controlling a laser movement track according to the 2-D code image and the micro pattern or a micro text, etching a film metal layer and forming a patterned hollowed-out structure;
the film comprising a transparent base layer and a metal layer covering the base layer.

9. An anti-counterfeit label, comprising:
a substrate;
a graphic layer, the graphic layer being formed with a 2-D code, the 2-D code being generated according to the method of any one of claims 1-8.

10. The anti-counterfeit label according to claim 9, characterized in that the graphic layer is a metal layer.

11. The anti-counterfeit label according to claim 10, characterized in that the metal layer is molded with a holographic anti-counterfeit pattern.

12. A 2-D code detecting method, comprising:
performing decoding and error correction based on an original 2-D code image to obtain first data;
obtaining a corresponding first 2-D code image based on the first data; and
detecting whether the original 2-D code image has anti-counterfeit information relative to the first 2-D code image.

13. The 2-D code detecting method according to claim 12, characterized in that the detecting whether the original 2-D code image has anti-counterfeit information relative to the first 2-D code image comprises:
detecting whether the original 2-D code image modifies pixels at at least two predetermined positions to a predetermined color relative to the first 2-D code image.

14. A 2-D code detecting method, comprising:
obtaining second data and an error correction codeword based on a 2-D code image;
performing error correction processing to the second data based on the error correction codeword to obtain first data; and
detecting whether the second data have anti-counterfeit information relative to the first data.

15. The 2-D code detecting method according to claim 14, characterized in that the detecting whether the second data have anti-counterfeit information relative to the first data comprises:
detecting whether data at at least one predetermined position in the first data are replaced with predetermined data or data obtained according to a predetermined rule; or
detecting whether the at least one predetermined position in the first data is added with the predetermined data or data obtained according to the predetermined rule.

16. The 2-D code detecting method according to claim 14, characterized in that the anti-counterfeit information and/or the first data are encrypted data.

17. A 2-D code generating apparatus, comprising:
an anti-counterfeit information adding unit configured to add anti-counterfeit information in first data to obtain second data;
an error correction codeword generating unit configured to generate a corresponding error correction codeword based on the first data; and
a 2-D code generating unit configured to generate a 2-D code image based on the second data and the error correction codeword.

18. A 2-D code generating apparatus, comprising:
a 2-D code image generating unit configured to generate a corresponding first 2-D code image having error correction data based on first data;
an image modifying unit configured to modify at least one region of the first 2-D code image in a predetermined manner to obtain a second 2-D code image;
wherein the modifying is kept within a predetermined limit such that the second 2-D code image can be decoded into the first data based on the error correction data, and the modifying is performed without changing an original image pattern in the corresponding region.

19. A 2-D code detecting apparatus, comprising:
an image parsing unit configured to obtain a first data by performing decoding and error correction based on an original 2-D code image;
an image generating unit configured to obtain a corresponding first 2-D code image based on the first data; and
an anti-counterfeit detection unit configured to detect whether the original 2-D code image has anti-counterfeit information relative to the first 2-D code image.

20. A 2-D code detecting apparatus, comprising:
an image decoding unit configured to obtain second data and error correction codeword based on a 2-D code image;
an error correction unit configured to perform error correction processing to the second data to obtain a first data; and
an anti-counterfeit detecting unit configured to detect whether the second data have anti-counterfeit information relative to the first data.
